(19) United States
(12) Patent Application Publication
(10) Pub. No.: US 2008/0263306 A1
(43) Pub. Date: Oct. 23, 2008

(54) Information processing apparatus having virtualization function, method of virtualization, and computer-readable recording medium

(75) Inventor: Akinori Tanizawa, Kato (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/081,029

(22) Filed: Apr. 9, 2008

(30) Foreign Application Priority Data
Apr. 17, 2007 (JP) 2007-108504

(51) Int. Cl. G06F 12/06

(52) U.S. Cl. 711/170; 711/E12.084

(57) ABSTRACT

An information processing apparatus having a virtualization function for creating a virtual disk based on a logical volume selected from a plurality of storage areas comprises a host device for performing information processing on a storage device, and a virtualization switch for connecting the host device to the storage device via a path. The host device includes a controller which computes information necessary for virtualization by acquiring information concerning the physical configuration of the storage device and information concerning the path from an information storing unit provided in a virtualization switch, selects specific logical volumes that match a pre-specified logical volume selection criterion, registers the selected logical volumes into a virtual storage pool, and creates the virtual disk by selecting a logical volume from the virtual storage pool. There is provided a method of virtualization which is implemented using the information processing apparatus, etc.

### INCORPORATION BY REFERENCE

Under provisions of 35 U.S.C. §119(e), Applicant claims the benefit of Japanese Patent Application No. 2007-108504 filed on Apr. 17, 2007, which is incorporated herein by reference.

### BACKGROUND OF THE INVENTION

1. Field of the Invention

The present invention relates to an information processing apparatus having a virtualization function for implementing virtual storage by creating a virtual disk based on information (data) on a specific logical volume selected from a plurality of storage areas provided by a plurality of storage media (physical disks) in a storage device. The invention also relates to a method of virtualization and a program for causing a computer to carry out the method of virtualization.

More specifically, the present invention pertains to a technique for implementing virtual storage on a large-capacity storage device such as a disk array device by creating a virtual disk in accordance with the attributes of the logical volumes that an operator (or user) desires to configure as virtual storage when migrating from the real environment operated by the operator to a virtual environment, and thereby achieving efficient and reliable management of information in the storage device.

The “logical volumes” here refer to the plurality of logical volumes obtained by logically partitioning the physical storage areas provided by the plurality of storage media in the storage device.

2. Description of the Related Art

In today's information society, the trend is toward converting every kind of information (data) into electronic form, and in the management of corporate information systems, data converted to electronic form, including data managed in accordance with the e-Document Law, must be stored on storage devices in a secure and reliable manner over long periods of time in order to meet corporate compliance requirements. It is expected that the amount of such electronic data will increase steadily in the future.

One problem facing such corporate information systems is how the ever increasing amounts of data can be managed efficiently and securely at low cost. On the other hand, measures for preventing information leakage must be implemented under the responsibility of each corporation based on the Personal Information Protection Law.

To solve the above problem, in the prior art, virtual storage that achieves excellent cost performance and information leakage prevention has been implemented by abstracting in accordance with a predetermined selection criterion (attribute) the specific logical volumes that the operator desires to configure as virtual storage from a plurality of storage areas within a storage device where electronic data are centrally stored, and by registering the thus abstracted logical volumes into a storage pool and creating a virtual disk from them.

Logical volume selection criterion is selected, for example, from the following three selection criteria.

(1) On-Line Volumes Created from On-Line Disk Devices

The logical volumes created only from on-line disk devices mounted in the storage device. The capacity is small, but data can be accessed at high speed, and the reliability is high. Such on-line logical volumes are selected in accordance with a performance priority mode that gives priority to the performance of the storage device.

(2) Near-Line Volumes Created from Near-Line Disk Devices

The logical volumes created only from near-line disk devices mounted in the storage device. The capacity is large, but the data access performance is inferior to that of the on-line disk devices. However, the cost of the near-line disk devices is lower than the on-line disk devices. Such near-line logical volumes are selected in accordance with a cost priority mode that gives priority to the cost of the storage device.

(3) Encrypted Logical Volumes Created from Encrypted Disk Devices

The logical volumes created only from storage devices encrypted using an encryption technique. Such encrypted logical volumes are selected in accordance with a security priority mode that gives priority to the security of the storage device achieved by encryption.

In a network environment such as exemplified by SAN (Storage Area Network), an information processing apparatus having a prior art virtualization function comprises a storage device having a plurality of storage areas provided by a plurality of storage media, and a host device having a server which performs various kinds of information processing on the storage device. Here, the plurality of storage media providing the storage areas in the storage device are physical volumes (physical disks).

The information processing apparatus further includes a virtualization switch for connecting between the host device at the higher level and the storage device at the lower level via a path comprising a single path or multiple paths. The virtualization switch establishes a path between the host device and the storage device so that processing can be performed to carry out the virtualization of the storage device.

In this configuration, the server in the host device is provided with a host bus adapter having a plurality of command lines, and the path is connected to this host bus adapter. On the other hand, the virtualization switch is provided with many channel ports, and the path is connected to the channel ports. That is, the host bus adapter of the server is connected to the channel ports of the virtualization switch via the path.

The storage device, on the other hand, is provided with a channel module and a channel adapter, and the channel module is connected to the channel ports of the virtualization switch via the path.

In the storage device, the storage space is partitioned into a plurality of logical volumes (zoning) in at least one zone. More specifically, in the information processing apparatus, on-line logical volumes created only from on-line disk devices mounted in the storage device, near-line logical volumes created only from near-line disk devices, and encrypted logical volumes created only from encrypted disk devices are generated as the results of the zoning in zone 0. That is, the zoning is performed in zone 0 to create logical volumes having three kinds of logical volume selection criteria, i.e., the on-line logical volumes, the near-line logical volumes, and the encrypted logical volumes.

A description will be given below of how virtual storage is implemented by creating a virtual disk and a virtual target in the information processing apparatus having the prior art virtualization function described above.

In the system configuration of the information processing apparatus, when migrating from the real environment operated by the operator (or user) to a virtual environment, the following steps A to F must be performed.

Step A: Create a virtual storage pool for specific logical volumes by selecting them from the storage device in accordance with the selection criterion for the logical volumes that the operator desires to configure as virtual storage. It is assumed here that the operator selects the on-line logical volumes from the plurality of storage areas in the storage device; therefore, the virtual storage pool for the on-line logical volumes is created here.

Step B: Register the on-line logical volumes into the virtual storage pool.

Step C: Create the virtual disk from the logical volumes registered in the virtual storage pool. Here, the virtual disk is created by selecting all of the plurality of logical volumes registered in the virtual storage pool, but generally, the virtual disk is created by selecting the logical volumes best suited for the construction of the virtual storage from among the plurality of logical volumes registered in the virtual storage pool.

Step D: Create a virtual cabinet.

Step E: Create a virtual target belonging to the created virtual cabinet.

Step F: Allocate the virtual disk to the virtual target.

The terms relating to the virtual storage construction will be briefly described below.

(a) The “virtual cabinet” is a logical cabinet for aggregating virtual disks in given units.

(b) The “virtual storage pool” is a logical container for storing physical disks from which to create a virtual disk.

(c) The “virtual target” is an access path for connecting the virtual disk to the server that performs tasks related to the virtualization of the storage device.

(d) The “virtual disk” is a disk comprising logical volumes that are not bounded by the physical attributes or capacities of physical disks.

When carrying out above steps A to F, provisions must be made not to create the virtual disk from a combination of on-line and near-line logical volumes if possible. The reason is that if the virtual disk is created by combining on-line and near-line logical volumes, data access performance and reliability may drop compared with the case where the virtual disk is created only from on-line logical volumes.

Provisions must also be made not to create the virtual disk by combining an encrypted logical volume with an on-line or near-line logical volume. The reason is that since on-line or near-line logical volumes are non-encrypted logical volumes, if data that must be protected against leakage is written to a virtual disk created from such a combination, the chance of information leakage will increase because the data may be written in non-encrypted form to a non-encrypted logical volume.

In this way, when carrying out the above steps to effect migration from the real environment operated by the operator to the virtual environment, the operator must be aware of the distinctions among the on-line logical volumes, near-line logical volumes, encrypted logical volumes, etc., within the storage device; this can increase the possibility of the operator performing an erroneous operation, and a longer time may be required to complete the migration from the real environment to the virtual environment.

In other words, the virtualization process in the above steps A to F requires that the operator himself specify the on-line logical volumes, near-line logical volumes, encrypted logical volumes, etc., by performing manual operations in an interactive manner on the display screen of the server while viewing the menu presented on the display screen. As a result, when performing the prior art virtualization process to effect migration from the real environment operated by the operator to the virtual environment, since the operator must be aware of the distinctions among the on-line logical volumes, near-line logical volumes, encrypted logical volumes, etc. within the storage device, the operator's manual operation becomes complicated, causing problems such as increased possibility of an erroneous operation and requiring a longer time to complete the migration from the real environment to the virtual environment.

For reference purposes, patent documents 1 and 2 are presented below as prior art documents related to the prior art virtualization such as described above.

Patent document 1 discloses the configuration of a storage device comprising a controller 3 for constructing a virtual volume 7 on a memory 6, the virtual volume 7 being made up of a low-speed volume 4 and a high-speed volume 5 and having a capacity of the same size as that of the low-speed volume 4, wherein when an application program 2A on a host 2 requests a data update, the write data is written to both the low-speed volume 4 and the high-speed volume 5, but the virtual volume 7 has a life tag indicating a preset data storage period, with provisions made so that when the data storage period expires, the data is erased only from the high-speed volume 5, but as long as the data is stored in the high-speed volume 5, access from the host 2 is processed using the data stored in the high-speed volume 5.

However, in the patent document 1, no mention is made of specific techniques for addressing the problem that occurs when migrating the storage device from a real environment to a virtual environment, i.e., when the operator performs processing to register logical volumes in a virtual storage pool and create a virtual disk by specifying on-line logical volumes, near-line logical volumes, encrypted logical volumes, etc., from within the storage device, the operator tends to perform an erroneous operation and a longer time may be required to migrate from the real environment to the virtual environment.

Patent document 2 discloses the configuration of a volume selection narrowing system comprising a first storage area for storing a plurality of logical volume data in which the attributes of a plurality of logical volumes are recorded; a second storage area for storing allocation destination candidate data in which an attribute relating to an allocation destination candidate selected from one or more allocation destination candidates is recorded; a third storage area for storing one or more history data that indicate that, of the plurality of logical volumes, which logical volume having what kind of attribute has been related to which allocation destination candidate having what kind of attribute; and a volume selection narrowing unit for narrowing the plurality of logical volume data down to one or more logical volume data based on the plurality of logical volume data, the allocation destination candidate data, and the one or more history data, and for outputting the contents of the thus narrowed logical volume data. This configuration serves to alleviate the burden of a human operator when selecting at least one logical volume from a plurality of logical volumes.

However, in patent document 2, as in patent document 1, no mention is made of specific techniques for addressing the problem that occurs when migrating the storage device from the real environment to the virtual environment, i.e., when the operator performs processing to register logical volumes in a virtual storage pool and create a virtual disk by specifying on-line logical volumes, near-line logical volumes, encrypted logical volumes, etc., from within the storage device, the operator tends to perform an erroneous operation and a longer time may be required to migrate from the real environment to the virtual environment.

Accordingly, neither patent document 1 nor patent document 2 can address the problem that occurs when the operator performs processing to register logical volumes in a virtual storage pool and create a virtual disk by specifying on-line logical volumes, near-line logical volumes, encrypted logical volumes, etc., from within the storage system in order to migrate the storage device from the real environment to the virtual environment.

Patent document 1: Japanese Unexamined Patent Publication (Kokai) No. 2006-139552

Patent document 2: Japanese Unexamined Patent Publication (Kokai) No. 2006-23797

### SUMMARY OF THE INVENTION

The present application has been made in view of the above problem, and an object is to provide an information processing apparatus having a virtualization function that can reduce the possibility of the operator performing an erroneous operation and can shorten the time required to migrate from the real environment to the virtual environment, by making provisions so that when migrating from the real environment operated by the operator to the virtual environment, the operator can create a virtual disk in accordance with the attributes of the logical volumes, such as on-line logical volumes, near-line logical volumes, encrypted logical volumes, etc., that the operator desires to configure as virtual storage, without having to be aware of the physical disk configuration of the storage device; it is also an object to provide a method of virtualization and a program for implementing the same.

To attain the above objects, an information processing apparatus disclosed in the present application comprises a storage device having a plurality of storage areas, a host device for performing various kinds of information processing on the storage device, and a virtualization switch for connecting the host device to the storage device via at least one path to perform processing for virtualization of the storage device, and has a virtualization function for implementing virtual storage by creating a virtual disk based on information on a specific logical volume selected from the plurality of storage areas, wherein the virtualization switch includes an information storing unit in which information concerning the physical configuration of the storage device and information concerning the path are pre-stored, and the host device includes logical a volume selection criterion selecting unit for specifying a selection criterion for selecting a plurality of logical volumes; and a controller which computes information necessary for the virtualization of the storage device by acquiring the information concerning the physical configuration of the storage device and the information concerning the path from the information storing unit, selects specific logical volumes that match the logical volume selection criterion specified by the logical volume selection criterion selecting unit, and registers the selected logical volumes into a virtual storage pool so that the virtual disk can be created by selecting an optimum logical volume from the virtual storage pool. In this case, the storage device, the host device, and the virtualization switch constitute the essential features of the information processing apparatus having the virtualization function.

Preferably, in the information processing apparatus, the logical volume selection criterion includes at least a performance priority mode that gives priority to the performance of the storage device, a cost priority mode that gives priority to the cost of the storage device, and a security priority mode that gives priority to the security of the storage device. For example, on-line logical volumes are selected in accordance with the performance priority mode, and near-line logical volumes are selected in accordance with the cost priority mode, while encrypted logical volumes are selected in accordance with the security priority mode.

Further preferably, the information processing apparatus is provided with a function for judging whether or not a dissimilar-attribute logical volume whose attribute does not match the specified logical volume selection criterion is allowed to be added to the virtual disk constructed from the logical volumes that match the specified logical volume selection criterion, thereby preventing the dissimilar-attribute logical volume from being added to the virtual disk.

Alternatively, the information processing apparatus comprises a host device for performing various kinds of information processing on a storage device having a plurality of storage areas, and has a virtualization function for implementing virtual storage by using at least one path for connecting the host device to the storage device and by creating a virtual disk based on information on a specific logical volume selected from the plurality of storage areas, wherein the host device includes a controller which computes information necessary for the virtualization of the storage device by acquiring pre-stored information concerning the physical configuration of the storage device and pre-stored information concerning the path, selects specific logical volumes that match a logical volume selection criterion pre-specified to select a plurality of logical volumes, and registers the selected logical volumes into a virtual storage pool so that the virtual disk can be created by selecting an optimum logical volume from the virtual storage pool. In this case, only the host device constitutes the essential feature of the information processing apparatus having the virtualization function.

On the other hand, a method of virtualization disclosed in the present application is a method for implementing virtual storage by using at least one path that connects a storage device having a plurality of storage areas to a host device for performing various kinds of information processing on the storage device and by creating a virtual disk based on information on a specific logical volume selected from the plurality of storage areas. The method comprises computing information necessary for the virtualization of the storage device by acquiring pre-stored information concerning the physical configuration of the storage device and pre-stored information concerning the path; selecting specific logical volumes that match a logical volume selection criterion pre-specified to select a plurality of logical volumes, and registering the selected logical volumes into a virtual storage pool; and creating the virtual disk by selecting an optimum logical volume from the virtual storage pool.

In the present application, there is also provided a computer-readable recording medium having stored thereon a program for carrying out a method for implementing virtual storage by using at least one path that connects a storage device having a plurality of storage areas to a host device for performing various kinds of information processing on the storage device and by creating a virtual disk based on information on a specific logical volume selected from the plurality of storage areas. The program is used for causing a computer to carry out computing information necessary for the virtualization of the storage device by acquiring pre-stored information concerning the physical configuration of the storage device and pre-stored information concerning the path; selecting specific logical volumes that match a logical volume selection criterion pre-specified to select a plurality of logical volumes, and registering the selected logical volumes into a virtual storage pool; and creating the virtual disk by selecting an optimum logical volume from the virtual storage pool.

### BRIEF DESCRIPTION OF THE DRAWINGS

The above objects and features of the present invention will be more apparent from the following description of some preferred embodiments with reference to the accompanying drawings, wherein:

FIG. 1 is a block diagram showing the configuration of an information processing apparatus having a prior art virtualization function;

FIG. 2 is a block diagram conceptually showing how a virtual disk and a virtual target are created in FIG. 1;

FIG. 3 is a flowchart explaining the virtualization process performed by a server in FIG. 1;

FIG. 4 is a block diagram showing the configuration of an information processing apparatus having a virtualization function according to an embodiment of the present application;

FIG. 5 is a block diagram showing the specific configuration of a server 10 or an operation management server 6 in FIG. 1;

FIG. 6 is a flowchart explaining a process for registering logical volumes into a virtual storage pool according to the present embodiment;

FIG. 7 is a diagram showing one example of a display screen presented at the time of the virtual storage pool registration according to the present embodiment;

FIG. 8 is a flowchart (part 1) explaining a virtual disk creation process according to the present embodiment;

FIG. 9 is a flowchart (part 2) explaining the virtual disk creation process according to the present embodiment;

FIG. 10 is a diagram showing one example of a display screen presented at the time of the virtual disk creation according to the present embodiment;

FIG. 11 is a flowchart (part 1) explaining a process for allowing/disallowing the addition of a dissimilar-attribute logical volume when extending the virtual disk capacity according to the present embodiment;

FIG. 12 is a flowchart (part 2) explaining the process for allowing/disallowing the addition of a dissimilar-attribute logical volume when the extending virtual disk capacity according to the present embodiment;

FIG. 13 is a diagram showing a display screen for explaining the selection of a dissimilar-attribute logical volume addition mode for extending the virtual disk capacity according to the present embodiment;

FIG. 14A is a diagram (part 1) showing a display screen for explaining the process for allowing/disallowing the addition of a dissimilar-attribute logical volume when extending the virtual disk capacity according to the present embodiment; and

FIG. 14B is a diagram (part 2) showing the display screen for explaining the process for allowing/disallowing the addition of a dissimilar-attribute logical volume when extending the virtual disk capacity according to the present embodiment.

### DESCRIPTION OF THE PREFERRED EMBODIMENTS

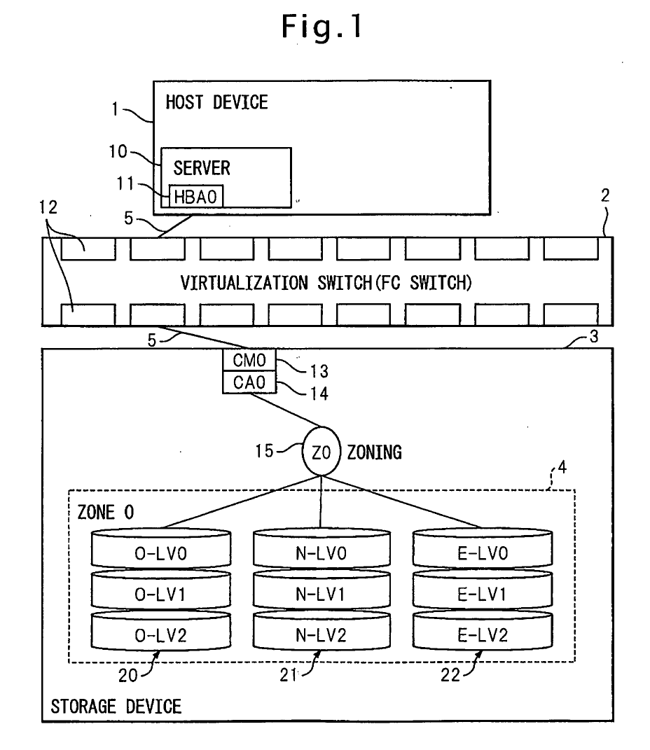

Before describing the configuration, operation, etc., of an information processing apparatus having a virtualization function according to an embodiment of the present application, an information processing apparatus having a prior art virtualization function and its associated problem will be described with reference to the accompanying drawings (FIGS. 1 to 3).

FIG. 1 is a block diagram showing the configuration of the information processing apparatus having the prior art virtualization function. The system configuration of the information processing apparatus having the prior art virtualization function in a network environment such as SAN (Storage Area Network) will be described below with reference to FIG. 1.

As shown in FIG. 1, the information processing apparatus having the prior art virtualization function comprises a storage device 3 having a plurality of storage areas 4 provided by a plurality of storage media, and a host device 1 having a server 10 which performs various kinds of information processing on the storage device 3. Here, the plurality of storage media providing the storage areas 4 in the storage device 3 are physical volumes (physical disks).

The information processing apparatus shown in FIG. 1 further includes a virtualization switch 2 (for example, an FC (Fibre Channel) switch using an optical fiber) for connecting between the host device 1 at the higher level and the storage device 3 at the lower level via a path 5 comprising a single path or multiple paths (in the example of FIG. 1, a single path is shown). The virtualization switch 2 establishes a path between the host device 1 and the storage device 3 so that processing can be performed to carry out the virtualization of the storage device 3.

In this configuration, the server 10 in the host device 1 is provided with a host bus adapter 11 having a plurality of command lines (in the example of FIG. 1, only HBA0 is shown), and the path 5 is connected to this host bus adapter 11. On the other hand, the virtualization switch 2 is provided with many channel ports 12, and the path 5 is connected to the channel ports 12. In other words, the host bus adapter 11 of the server 10 is connected to the channel ports 12 of the virtualization switch 2 via the path 5.

The storage device 3, on the other hand, is provided with a channel module (in the example of FIG. 1, CM0) 13 and a channel adapter (in the example of FIG. 1, CA0) 14, and the channel module 13 is connected to the channel ports 12 of the virtualization switch 2 via the path 5 (in the example of FIG. 1, one channel module CM0 is connected to the channel ports 12 of the virtualization switch 2 via the path 5).

In the storage device 3, the storage space is partitioned into a plurality of logical volumes (zoning: Z0 in the example of FIG. 1) in at least one zone 15 (zone 0 in the example of FIG. 1). More specifically, in the information processing apparatus of FIG. 1, on-line logical volumes (O-LV0, O-LV1, and O-LV2) 20 created only from on-line disk devices mounted in the storage device 3, near-line logical volumes (N-LV0, N-LV1, and N-LV2) 21 created only from near-line disk devices, and encrypted logical volumes (E-LV0, E-LV1, and E-LV2) 22 created only from encrypted disk devices are generated as shown as the results of the zoning (Z0) in zone 0. In other words, the zoning is performed in zone 0 to create logical volumes having three kinds of logical volume selection criteria, i.e., the on-line logical volumes 20, the near-line logical volumes 21, and the encrypted logical volumes 22. As described above, in the information processing apparatus of FIG. 1, a system of a single path configuration of HBA0-CM0-CA0 is constructed.

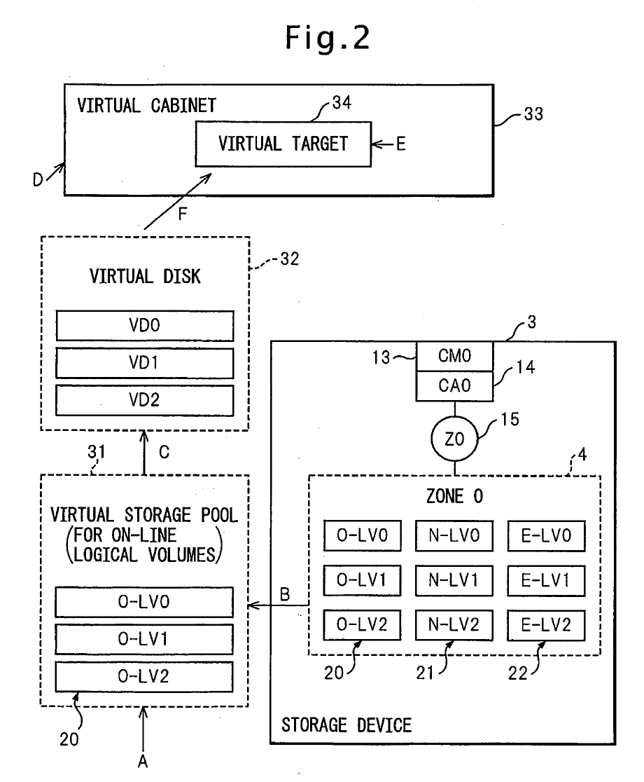

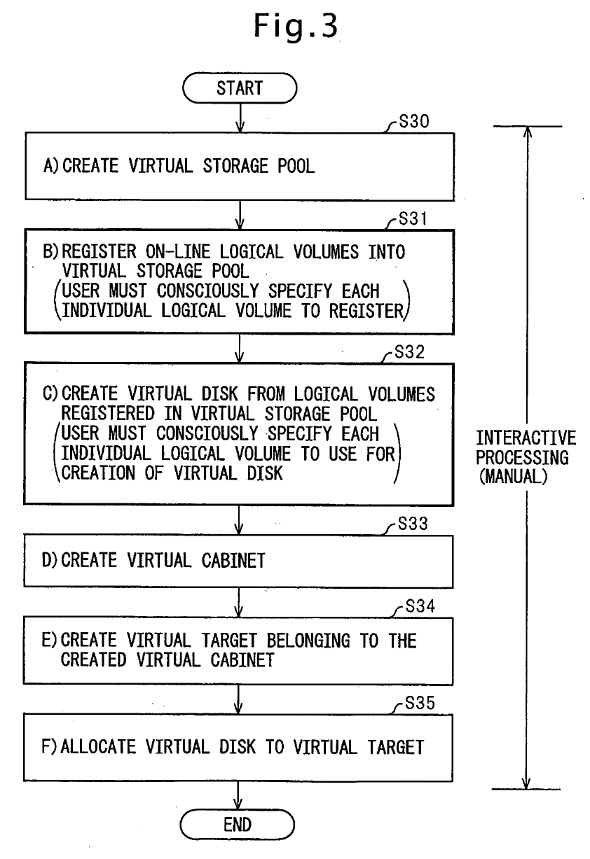

FIG. 2 is a block diagram conceptually showing how a virtual disk and a virtual target are created in FIG. 1, and FIG. 3 is a flowchart explaining the virtualization process performed by the server in FIG. 1.

Referring to FIG. 2, a description will be given below of how virtual storage is implemented by creating a virtual disk and a virtual target in the information processing apparatus having the prior art virtualization function.

In the system configuration of the information processing apparatus such as shown in FIG. 1, when migrating from the real environment operated by the operator (or user) to a virtual environment, the following steps A to F must be performed.

In FIG. 2, virtual disks VD0 (Virtual Disk 0), VD1 (Virtual Disk 1), and VD2 (Virtual Disk 2) are shown as examples of the virtual disk 32, while LV0 (Logical Volume 0), LV1 (Logical Volume 1), and LV2 (Logical Volume 2) are shown as examples of the logical volumes. The symbols A, B, C, D, E, and F shown below correspond to the respective symbols A, B, C, D, E, and F shown in FIGS. 2 and 3.

Step A: Create a virtual storage pool 31 for specific logical volumes by selecting them from the storage device 3 in accordance with the selection criterion for the logical volumes that the operator desires to configure as virtual storage. In the example of FIG. 2, since it is assumed that the operator selects the on-line logical volumes 20 from the plurality of storage areas 4 in the storage device 3, the virtual storage pool 31 for the on-line logical volumes is created.

Step B: Register the on-line logical volumes (o-LV0, O-LV1, and O-LV2) 20 into the virtual storage pool 31.

Step C: Create the virtual disk 32 (VD0, VD1, and VD2) from the logical volumes (O-LV0, O-LV1, and O-LV2) registered in the virtual storage pool 31. Here, the virtual disk 32 is created by selecting all of the plurality of logical volumes registered in the virtual storage pool 31, but generally, the virtual disk 32 is created by selecting the logical volumes best suited for the construction of the virtual storage from among the plurality of logical volumes registered in the virtual storage pool 31.

Step D: Create a virtual cabinet 33.

Step E: Create a virtual target 34 belonging to the created virtual cabinet 33.

Step F: Allocate the virtual disk 32 (VD0, VD1, and VD2) to the virtual target 34.

The terms relating to the virtual storage construction will be briefly described below.

(a) The “virtual cabinet” is a logical cabinet for aggregating virtual disks in given units.

(b) The “virtual storage pool” is a logical container for storing physical disks from which to create a virtual disk.

(c) The “virtual target” is an access path for connecting the virtual disk to the server that performs tasks related to the virtualization of the storage device.

(d) The “virtual disk” is a disk comprising logical volumes that are not bounded by the physical attributes or capacities of physical disks.

When carrying out the above steps A to F, provisions must be made not to create the virtual disk from a combination of on-line and near-line logical volumes if at all possible. The reason is that if the virtual disk is created by combining on-line and near-line logical volumes, data access performance and reliability may drop compared with the case where the virtual disk is created only from on-line logical volumes.

Provisions must also be made not to create the virtual disk by combining an encrypted logical volume with an on-line or near-line logical volume. The reason is that since on-line or near-line logical volumes are non-encrypted logical volumes, if data that must be protected against leakage is written to a virtual disk created from such a combination, the chance of information leakage will increase because the data may be written in non-encrypted form to a non-encrypted logical volume.

In this way, when carrying out the processing shown in FIG. 2 to effect migration from the real environment operated by the operator to the virtual environment, the operator must be aware of the distinctions among the on-line logical volumes, near-line logical volumes, encrypted logical volumes, etc., within the storage device; this can increase the possibility of the operator performing an erroneous operation, and a longer time may be required to complete the migration from the real environment to the virtual environment.

The virtualization process performed by the server of the prior art information processing apparatus will be described below with reference to the flowchart of FIG. 3.

When the storage device virtualization process is started, first a virtual storage pool for specific logical volumes is created as shown in step S30 by selecting the logical volumes from the storage device in accordance with the logical volume selection criterion pre-specified by the operator (or user) (this step corresponds to the step A in FIG. 2). Next, the specific logical volumes are registered into the virtual storage pool, as shown in step S31 (this step corresponds to the step B in FIG. 2). In this case, the operator must individually specify which logical volume from the storage areas in the storage device is to be registered into the virtual storage pool, and must select each logical volume to be registered into the virtual storage pool, by bearing in mind the type of the storage device and the RAID (Redundant Arrays of Inexpensive Disks) level chosen to provide redundancy for the storage device.

Further, as shown in step S32, a virtual disk is created from the logical volumes registered in the virtual storage pool (this step corresponds to the step C in FIG. 2). In this case also, the operator must specify each individual logical volume to select from the virtual storage pool for the creation of the virtual disk.

The virtual cabinet 33 is created as shown in step S33 (this step corresponds to the step D in FIG. 2), after which the process proceeds to step S34. The virtual target 34 belonging to the created virtual cabinet 33 is created in step S34 (this step corresponds to the step E in FIG. 2). Finally, the virtual disk 32 (VD0, VD1, and VD2) is allocated to the virtual target 34 as shown in step S35 (this step corresponds to the step F in FIG. 2), whereupon the virtualization process by the server is terminated.

The virtualization process in steps S30 to S35 in FIG. 3 requires that the operator himself specify the on-line logical volumes, near-line logical volumes, encrypted logical volumes, etc. by performing manual operations in an interactive manner on the display screen of the server while viewing the menu presented on the display screen. As a result, when performing the prior art virtualization process of FIG. 3 to effect migration from the real environment operated by the operator to the virtual environment, since the operator must be aware of the distinctions among the on-line logical volumes, near-line logical volumes, encrypted logical volumes, etc. within the storage device, the operator's manual operation becomes complicated, causing inconveniences such as increased possibility of an erroneous operation and requiring a longer time to complete the migration from the real environment to the virtual environment.

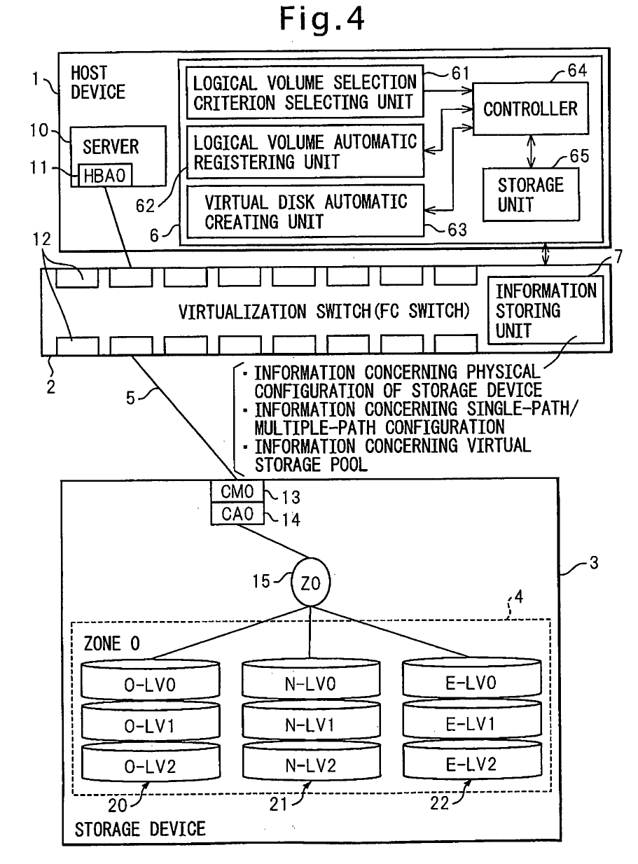

Next, the configuration, operation, etc. of the information processing apparatus having the virtualization function according to the present embodiment provided to address the above inconveniences will be described in detail below with reference to the accompanying drawings (FIGS. 4 to 14).

FIG. 4 is a block diagram showing the configuration of the information processing apparatus having the virtualization function according to the present embodiment. The configuration of the information processing apparatus having the virtualization function according to the present embodiment is shown in simplified form. In the description given hereinafter, components identical or similar to those described above are designated by the same reference numerals.

In the information processing apparatus of the embodiment shown in FIG. 4, as in the information processing apparatus shown in FIG. 1, there are provided a large-capacity storage device 3, such as a disk array device, having a plurality of storage areas 4 provided by a plurality of storage media 4; and a host device 1 which performs various kinds of information processing on the storage device 3. Here, the plurality of storage media providing the storage areas 4 in the storage device 3 are physical volumes.

Similar to the information processing apparatus shown in FIG. 1, the information processing apparatus of the embodiment shown in FIG. 4 further includes a virtualization switch 2 for connecting between the host device 1 at the higher level and the storage device 3 at the lower level via a path 5 comprising a single path or multiple paths (in the example of FIG. 4, a single path is shown). The virtualization switch 2 establishes a path between the host device 1 and the storage device 3 so that processing can be performed to carry out the virtualization of the storage device 3. Preferably, the virtualization switch 2 is constructed from an FC switch containing a plurality of switch devices using optical fiber.

The server 10 in the host device 1, as in the server 10 previously shown in FIG. 1, is provided with a host bus adapter 11 having a plurality of command lines (in the example of FIG. 4, HBA0), and the path 5 is connected to this host bus adapter 11. On the other hand, the virtualization switch 2, as in the virtualization switch 2 previously shown in FIG. 1, is provided with many channel ports 12, and the path 5 is connected to the channel ports 12.

On the other hand, the storage device 3, as in the storage device 3 previously shown in FIG. 1, is provided with a channel module (in the example of FIG. 4, CM0) 13 and a channel adapter (in the example of FIG. 4, CA0) 14, and the channel module 13 is connected to the channel ports 12 of the virtualization switch 2 via the path 5.

In the storage device 3, as in the storage device 3 previously shown in FIG. 1, the storage space is partitioned into a plurality of logical volumes (zoning: Z0 in the example of FIG. 4) in at least one zone 15 (zone 0 in the example of FIG. 4). More specifically, in the information processing apparatus of the embodiment shown in FIG. 4, on-line logical volumes (O-LV0, O-LV1, and O-LV2) 20 created only from on-line disk devices mounted in the storage device 3, near-line logical volumes (N-LV0, N-LV1, and N-LV2) 21 created only from near-line disk devices, and encrypted logical volumes (E-LV0, E-LV1, and E-LV2) 22 created only from encrypted disk devices are generated as shown as the results of the zoning (Z0) in zone 0. In the illustrated example, the zoning is performed in zone 0 to create logical volumes having three kinds of logical volume selection criteria, i.e., the on-line logical volumes 20, the near-line logical volumes 21, and the encrypted logical volumes 22.

In addition to the server 10, an operation management server 6 which constitutes a feature of the present invention is provided in the host device 1. The server 10 sends the plurality of command lines created and stored in advance (in the example of FIG. 4, HBA0) to the storage device 3 in order to perform various kinds of information processing such as information write and read operations on the storage device 3.

The operation management server 6 comprises a logical volume selection criterion selecting unit 61 for specifying a selection criterion for selecting a plurality of logical volumes from the storage device 3; a logical volume automatic registering unit 62 for automatically selecting specific logical volumes that match the logical volume selection criterion specified by the logical volume selection criterion selecting unit 61, and for registering the selected logical volumes into a virtual storage pool; a virtual disk automatic creating unit 63 for automatically creating a virtual disk by automatically selecting optimum logical volumes from the logical volumes registered in the virtual storage pool; and a controller 64 for centrally controlling the logical volume automatic registering unit 62, the virtual disk automatic creating unit 63, etc. Preferably, the logical volume selection criterion selecting unit 61 is implemented as a logical volume selection criterion selecting button, etc., displayed on the display screen of the operation management server 6.

In the operation management server 6, when the operator just specifies via a client or the like (not shown) the selection criterion for the logical volumes that he desires to configure as virtual storage, the specific logical volumes that match the specified logical volume selection criterion are automatically selected and registered into the virtual storage pool, and the virtual disk can be created automatically from the logical volumes registered in the virtual storage pool. In this way, virtual storage can be easily implemented by following a simple operating procedure for migrating from the real environment to the virtual environment.

As will be described later, the functions of the logical volume automatic registering unit 62, the virtual disk automatic creating unit 63, and the controller 64 are implemented by executing various programs (software) on a CPU (Central Processing Unit) of a general-purpose personal computer.

The controller 6 shown in FIG. 4 is provided with a storage unit 65 which stores various programs for executing the virtualization to migrate the storage device from the real environment to the virtual environment and various kinds of data related to the virtualization of the storage device. Preferably, the storage unit 65 is constructed from a ROM (Read-Only Memory), a RAM (Random Access Memory), or the like.

The virtualization switch 2 includes an information storing unit 7 in which information concerning the physical configuration of the storage device 3, information concerning the path (single path or multiple paths) between the host device and the storage device, and information concerning the virtual storage pool are pre-stored. Preferably, the information storing unit 7 is constructed from a RAM or a ROM.

When constructing virtual storage in the embodiment of FIG. 4, the operation management server 6 acquires the information concerning the physical configuration of the storage device 3 and the information concerning the configuration of the path between the host device and the storage device from the information storing unit 7 (or from the storage unit 65 of the operation management server 6), and automatically computes the information concerning the path, etc., necessary for the virtualization of the storage device.

More specifically, the path to be established between the host adapter 11 in the host device 1 and the zone 15 in the storage device 2 via the channel module 13 and channel adapter 14 is automatically computed by the operation management server 6. Here, the single path of HBA0-CM0-CA0 is computed.

In the information processing apparatus of the embodiment shown in FIG. 4, when effecting the migration from the real environment operated by the operator to the virtual environment, the operator need not be aware of the configuration of the physical disks in the storage device 3 but need only specify the selection criterion for the logical volumes that he desires to configure as virtual storage, whereupon the specific logical volumes that match the specified logical volume selection criterion are automatically selected and registered into the virtual storage pool, and the virtual disk is automatically created, thus achieving the construction of the virtual storage in a simple procedure.

As a result, according to the embodiment of FIG. 4, since the operating procedure that the operator performs when migrating the storage device from the real environment to the virtual environment is simplified, the possibility of the operator performing an erroneous operation can be reduced, and the time required to migrate from the real environment to the virtual environment can also be reduced.

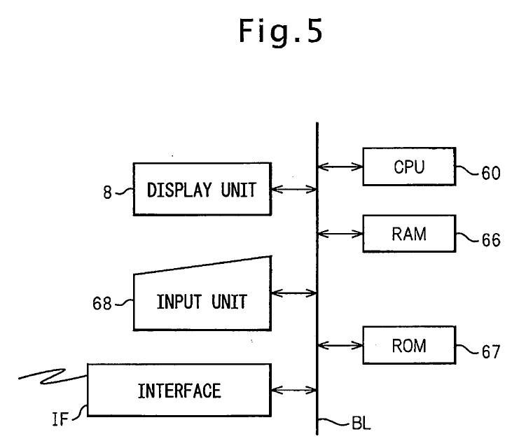

FIG. 5 is a block diagram showing the specific configuration of the server 10 or the operation management server 6 in FIG. 4. Since the server 10 and the operation management server 6 in FIG. 4 are essentially identical in hardware configuration, the specific hardware configuration represented by the operation management server 6 that has a direct relationship to the configuration of the present invention is shown here.

In FIG. 5, the controller 64 in the operation management server 6 shown in FIG. 4 is implemented by a computer CPU 60. In other words, the function of the controller 64 in the operation management server 6 is implemented by computer software (application software).

The hardware configuration of FIG. 5 further includes a RAM 66 or a ROM 67 as the storage unit for storing programs for executing the storage virtualization to achieve the virtual storage construction according to the present invention and various kinds of data related to the storage virtualization. Here, a RAM or ROM internal to the CPU 60 may be used as the storage unit. Further, the information concerning the physical configuration of the storage device 3, the information concerning the configuration of the path between the host device and the storage device, and the information concerning the virtual storage pool may be stored in this storage unit, rather than storing them in the information storing unit 7 (see FIG. 4).

The hardware configuration of FIG. 5 further includes an input unit 68 comprising a keyboard, mouse, operation buttons, etc. When the operator operates the keyboard, mouse, operation buttons, etc. on the input unit 68, the logical volume selection criterion specified by the operator (for example, performance priority mode, cost priority mode, or security priority mode) and information concerning the selected specific logical volumes and other logical volume attributes (for example, the type of the storage device and the RAID level of the storage device) are stored in the storage unit such as the RAM 66 or the ROM 67.

Further, in the hardware configuration of FIG. 5, a display unit 8 is provided which displays on the display screen the logical volume selection criterion specified by the operator and various kinds of information such as the information concerning other logical volume attributes (for example, the type of the storage device and the RAID level of the storage device), the information concerning the physical configuration of the storage device, and the information concerning the configuration of the path between the host device and the storage device.

The CPU 60, RAM 66, ROM 67, input unit 68, and display unit 8 described above are interconnected via a bus line BL. It is also possible to connect the information processing apparatus, including the host device 1, virtualization switch 2, and storage device 3 (see FIG. 4), to other apparatus (for example, a system equipped with a database, backup control equipment, etc.) via a SAN or any other interface IF.

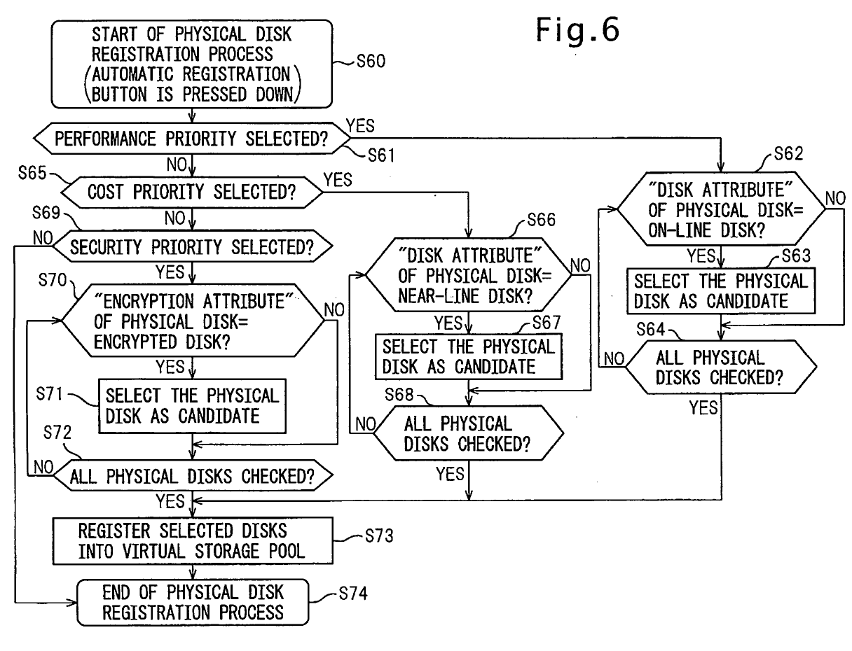

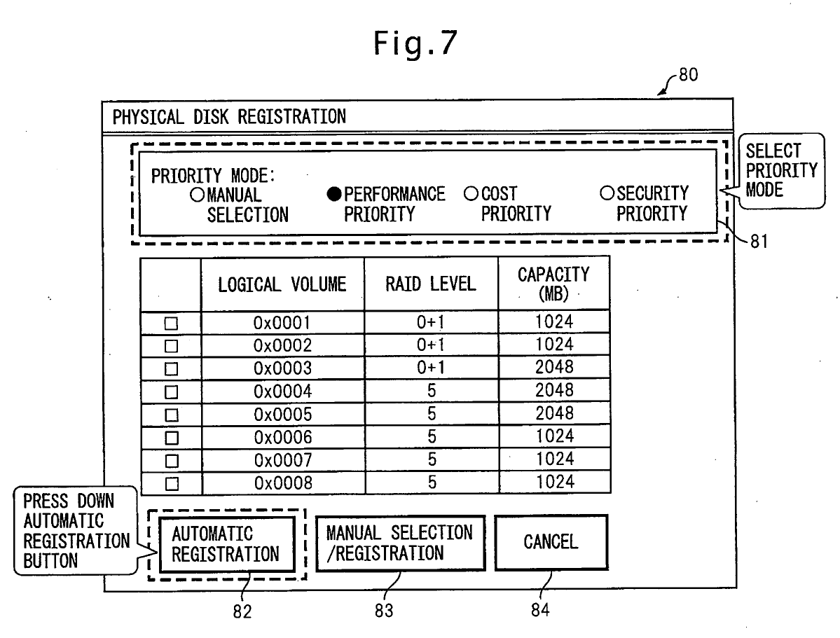

FIG. 6 is a flowchart explaining the process for registering the logical volumes into the virtual storage pool according to the present embodiment, and FIG. 7 is a diagram showing one example of the display screen presented at the time of the virtual storage pool registration according to the present embodiment.

The flow for carrying out the process for registering the logical volumes into the virtual storage pool under the control of the CPU of the information processing apparatus according to the present embodiment will be described below with reference to FIG. 6.

First, as shown in step S60, the operator operates the logical volume selection criterion selecting button 81 (see FIG. 7) to select the selection criterion for the logical volumes that he desires to configure as virtual storage, and then presses down the automatic registration button 82 (see FIG. 7) to initiate the process for selecting the specific logical volumes from the physical disks in the storage device and for registering them into the virtual storage pool.

Next, when it is detected that the operator has selected the performance priority mode as the logical volume selection criterion as shown in step S61, the process proceeds to step S62. In step S62, each physical disk in the storage device is checked to see if the “disk attribute” of the physical disk is an on-line disk that forms an on-line disk device. If it is determined that the disk attribute of the thus checked physical disk is an on-line disk, the physical disk is selected as a logical volume candidate, as shown in step S63. The processing in steps S62 and S63 is repeated until all the physical disks are checked (step S64).

On the other hand, when it is detected that the operator has selected the cost priority mode as the logical volume selection criterion as shown in step S65, the process proceeds to step S66. In step S66, each physical disk in the storage device is checked to see if the “disk attribute” of the physical disk is a near-line disk that forms a near-line disk device. If it is determined that the disk attribute of the thus checked physical disk is a near-line disk, the physical disk is selected as a logical volume candidate, as shown in Figure S67. The processing in steps S66 and S67 is repeated until all the physical disks are checked (step S68).

On the other hand, when it is detected that the operator has selected the security priority mode as the logical volume selection criterion as shown in step S70, the process proceeds to step S71. In step S71, each physical disk in the storage device is checked to see if the “encryption attribute” of the physical disk is an encrypted disk that forms an encrypted disk device. If it is determined that the encryption attribute of the thus checked physical disk is an encrypted disk, the physical disk is selected as a logical volume candidate, as shown in Figure S71. The processing in steps S70 and S71 is repeated until all the physical disks are checked (step S72).

Then, as shown in step S73, the physical disks selected as the candidate physical disks in accordance with the performance priority mode, cost priority mode, or security priority mode are registered into the virtual storage pool as the on-line logical volumes, near-line logical volumes, or encrypted logical volumes, respectively.

Finally, the process for registering the selected physical disks into the virtual storage pool is terminated as shown in step S74.

Next, referring to FIG. 7, one example of the display screen will be described below to explain how the physical disks automatically selected in accordance with the performance priority mode, cost priority mode, or security priority mode are registered into the virtual storage pool.

In FIG. 7, the RAID levels of eight physical disks (logical volumes 0x0001 to 0x000B) and their capacities are shown on the display screen 80 of the display unit 8 (see FIG. 5) when registering the physical disks. Here, the RAID level of each of the logical volumes 0x0001 to 0x0003 is a combination of RAID 0 and RAID 1, while the RAID level of each of the logical volumes 0x0004 to 0x0008 is RAID 5. On the other hand, the capacity of each of the logical volumes 0x0001, 0x0002, and 0x0006 to 0x0008 is 1024 MB (megabytes), while the capacity of each of the logical volumes 0x0003 to 0x0005 is 2048 MB.

The display screen 80 of FIG. 7 also shows the logical volume selection criterion selecting button 81 for selecting the logical volume selection criterion. Performance priority mode, cost priority mode, and security priority mode are shown as selectable logical volume selection criteria. The illustrated example shows the display screen 80 when the operator has selected the performance priority mode by operating the logical volume selection criterion selecting button 81. Manual selection mode is also shown as a mode selectable by the logical volume selection criterion selecting button 81; when the manual selection mode is selected, the operator can specify each individual logical volume manually.

The display screen 80 of FIG. 7 further shows the automatic registration button 82 and manual selection/registration button 83. When the operator presses down the automatic registration button 82, the logical volumes that match the logical volume selection criterion are automatically selected and registered into the virtual storage pool. On the other hand, when the operator presses down the manual selection/registration button 83, the logical volumes individually specified by the operator through manual operations are selected and registered into the virtual storage pool. A cancel switch 84 is also provided which is used to erase data entered by an erroneous operation of the logical volume selection criterion selecting button 81, the automatic registration button 82, or the manual selection/registration button 83.

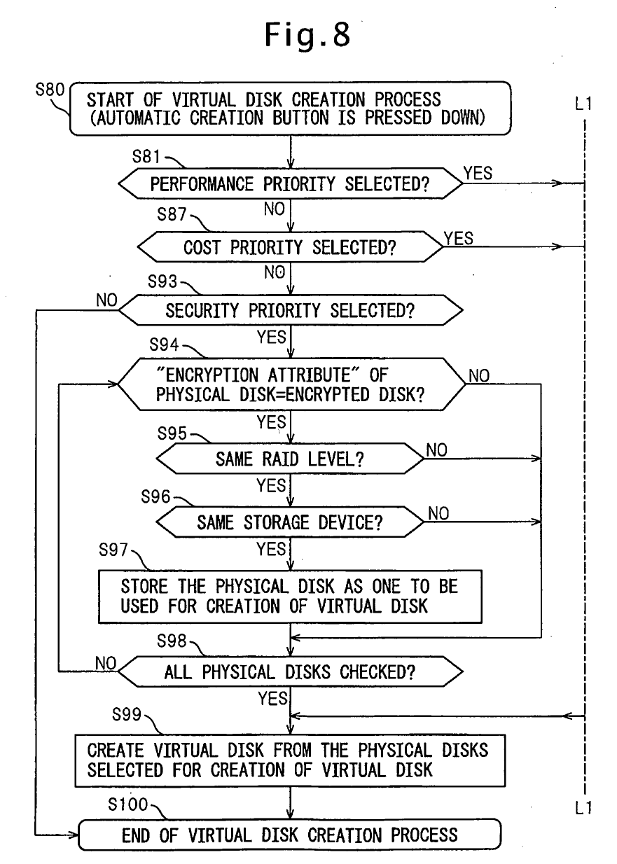

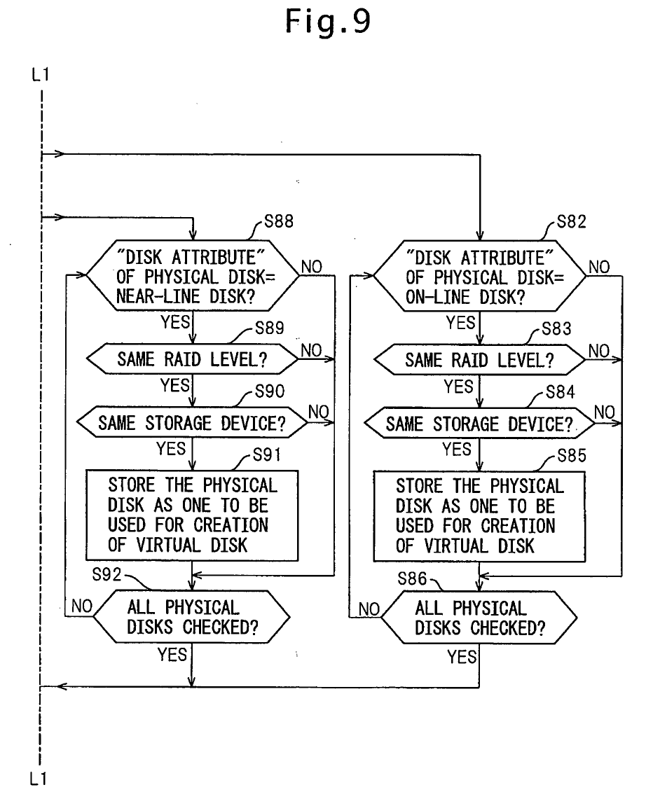

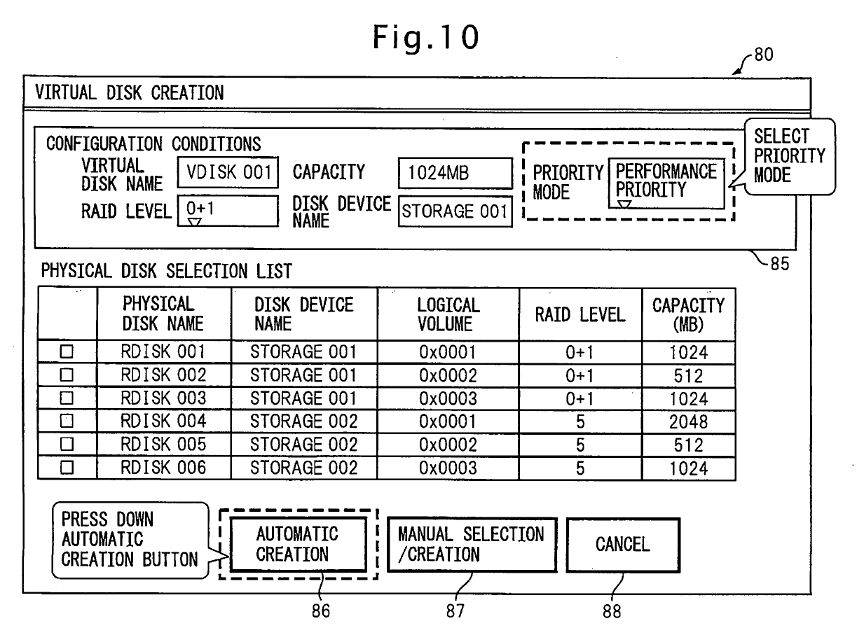

FIGS. 8 and 9 are part 1 and part 2, respectively, of a flowchart explaining the process for creating a virtual disk according to the present embodiment, and FIG. 10 is a diagram showing one example of the display screen presented at the time of the virtual disk creation.

The flow for carrying out the virtual disk creation process under the control of the CPU of the information processing apparatus according to the present embodiment will be described below with reference to FIGS. 8 and 9.

First, as shown in step S80 of FIG. 8, the operator operates the virtual disk configuration condition selecting button 85 (see FIG. 10) to select the priority mode for selecting the logical volumes from the virtual storage pool, and then presses down the automatic creation button 86 (see FIG. 10) to initiate the process for creating the virtual disk by selecting the specific logical volumes from the logical volumes registered in the virtual storage pool.

Next, when it is detected, as shown in step S81 of FIG. 8, that the operator has selected the performance priority mode as the selection criterion for selecting the logical volumes from the virtual storage pool, the process proceeds to step S82 of FIG. 9. In step S82, each of the physical disks corresponding to the respective logical volumes stored in the virtual storage pool is checked to see if the “disk attribute” of the physical disk is an on-line disk that forms an on-line disk device.

If it is determined that the disk attribute of the thus checked physical disk (i.e., the corresponding logical volume stored in the virtual storage pool) is an on-line disk, then it is checked, as shown in step S83 of FIG. 9, whether or not the checked physical disk has been selected from the plurality of storage devices having the same RAID level. It is further checked, as shown in step S84 of FIG. 9, whether or not the checked physical disk has been selected from the same storage device. If it is determined that the checked physical disk has been selected from the same storage device of the same RAID level, the checked physical disk is stored in the storage unit as a physical disk to be used for the creation of the virtual disk, as shown in step S85 of FIG. 9.

The processing in steps S82 to S85 is repeated until all the physical disks corresponding to the respective logical volumes stored in the virtual storage pool are checked (step S86 of FIG. 9).

On the other hand, when it is detected, as shown in step S87 of FIG. 8, that the operator has selected the cost priority mode as the selection criterion for selecting the logical volumes from the virtual storage pool, the process proceeds to step S88 of FIG. 9. In step S88, each of the physical disks corresponding to the respective logical volumes stored in the virtual storage pool is checked to see if the “disk attribute” of the physical disk is a near-line disk that forms a near-line disk device.

If it is determined that the disk attribute of the thus checked physical disk (i.e., the corresponding logical volume stored in the virtual storage pool) is a near-line disk, then it is checked, as shown in step S89 of FIG. 9, whether or not the checked physical disk has been selected from the plurality of storage devices having the same RAID level. It is further checked, as shown in step S90, whether or not the checked physical disk has been selected from the same storage device. If it is determined that the checked physical disk has been selected from the same storage device of the same RAID level, the checked physical disk is stored in the storage unit as a physical disk to be used for the creation of the virtual disk, as shown in step S91 of FIG. 9.

The processing in steps S88 to S91 is repeated until all the physical disks corresponding to the respective logical volumes stored in the virtual storage pool are checked (step S92 of FIG. 9).

Next, when it is detected, as shown in step S93 of FIG. 8, that the operator has selected the security priority mode as the selection criterion for selecting the logical volumes from the virtual storage pool, the process proceeds to step S94 of FIG. 8. In step S94, each of the physical disks corresponding to the respective logical volumes stored in the virtual storage pool is checked to see if the “encryption attribute” of the physical disk is an encrypted disk that forms an encrypted disk device.

If it is determined that the encryption attribute of the thus checked physical disk (i.e., the corresponding logical volume stored in the virtual storage pool) is an encrypted disk, then it is checked, as shown in step S95 of FIG. 8, whether or not the checked physical disk has been selected from the plurality of storage devices having the same RAID level. It is further checked, as shown in step S96 of FIG. 8, whether or not the checked physical disk has been selected from the same storage device. If it is determined that the checked physical disk has been selected from the same storage device of the same RAID level, the checked physical disk is stored in the storage unit as a physical disk to be used for the creation of the virtual disk, as shown in step S97 of FIG. 8.

The processing in steps S94 to S97 is repeated until all the physical disks corresponding to the respective logical volumes stored in the virtual storage pool are checked (step S98 of FIG. 8).

Then, as shown in step S99 of FIG. 8, the virtual disk is created based on the physical disks selected in accordance with the performance priority mode, cost priority mode, or security priority mode for the creation of the virtual disk (that is, based on the specific logical volumes selected from the logical volumes registered in the virtual storage pool).

Finally, the process for creating the virtual disk from the logical volumes selected from the virtual storage pool is terminated as shown in step S100 of FIG. 8.

According to the flowchart shown in FIGS. 8 and 9, even if the operator is not aware of the configuration of the physical disks in the storage device, virtual storage using the on-line logical volumes selected in accordance with the performance priority mode can be easily implemented. Similarly, even if the operator is not aware of the configuration of the physical disks in the storage device, virtual storage using the near-line logical volumes selected in accordance with the cost priority mode can be easily implemented. Further, even if the operator is not aware of the configuration of the physical disks in the storage device, virtual storage using the encrypted logical volumes selected in accordance with the security priority mode can be easily implemented.

Next, referring to FIG. 10, one example of the display screen will be described below to explain how the virtual disk is created based on the physical disks automatically selected in accordance with the performance priority mode, cost priority mode, or security priority mode.

In FIG. 10, the disk device names of two disk devices (STORAGE 001 and STORAGE 002), the physical disk names of six physical disks (RDISK 001 to RDISK 006), and three logical volumes (0x001 to 0x003) in each disk device are shown (in the form of a physical disk selection list) on the display screen 80 of the display unit 8 (see FIG. 5) for the virtual disk creation. The RAID levels of the six physical disks and their capacities are also shown. Here, the RAID level of each of the physical disks 001 to 003 is a combination of RAID 0 and RAID 1, while the RAID level of each of the physical disks 004 to 006 is RAID 5. On the other hand, the capacity of each of the physical disks 001, 003, and 006 is 1024 MB, and the capacity of each of the physical disks 002 and 005 is 512 MB, while the capacity of the physical disk 004 is 2048 MB.

The display screen 80 of FIG. 10 also shows the virtual disk configuration condition selecting button 85 for selecting the priority mode when creating the virtual disk. Here, the priority mode is selectable from among the performance priority, cost priority, and security priority modes. The virtual disk name (VDISK 001) of the virtual disk to be created, the capacity (1024 MB) and RAID level (combination of RAID 0 and RAID 1) of the virtual disk, and the disk device name (STORAGE 001) of the disk device are also shown on the virtual disk configuration condition selecting button 85. The illustrated example shows the display screen 80 when the operator has selected the performance priority mode by operating the virtual disk configuration condition selecting button 85. It is also possible to select the manual selection mode by the virtual disk configuration condition selecting button 85; i.e., when the manual selection mode is selected, the operator can manually specify each individual logical volume to be used for the creation of the virtual disk.

The display screen 80 of FIG. 10 further shows the automatic creation button 86 and manual selection/creation button 87. When the operator depresses the automatic creation button 86, the virtual disk is created by automatically selecting the logical volumes from the virtual storage pool in accordance with the selected priority mode. On the other hand, when the operator depresses the manual selection/creation button 87, the virtual disk is created by selecting the logical volumes individually specified by the operator through manual operations. A cancel switch 88 is also provided which is used to erase data entered by an erroneous operation of the virtual disk configuration condition selecting button 85, the automatic creation button 86, or the manual selection/creation button 87.

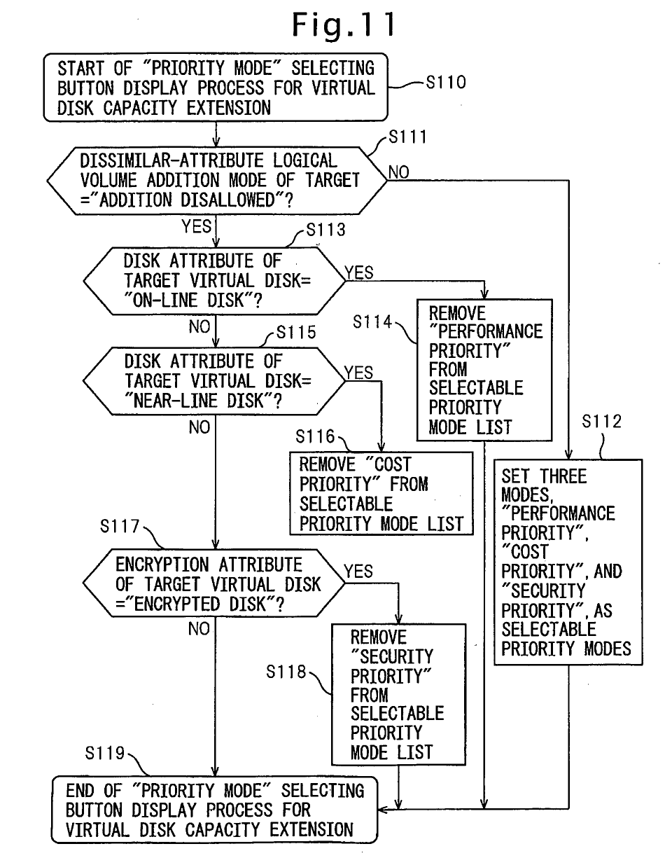

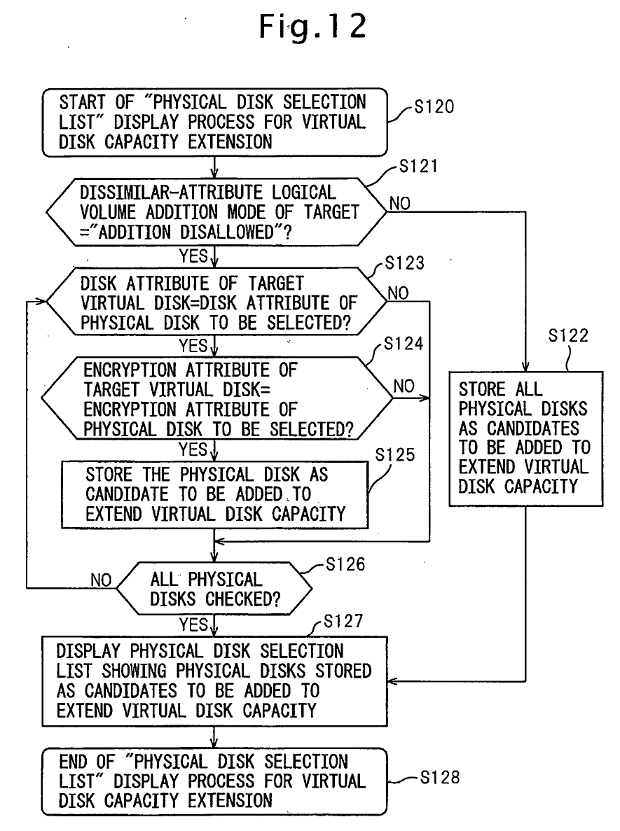

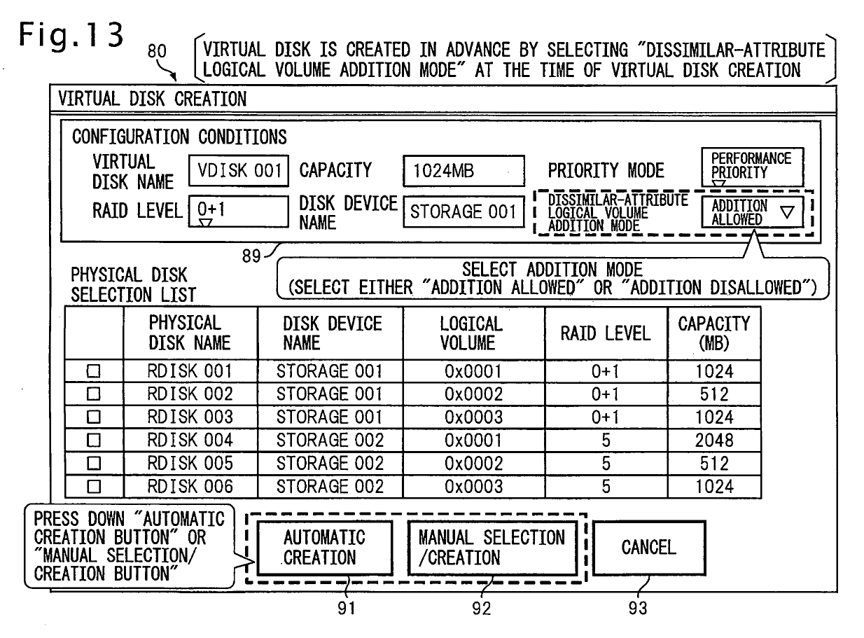

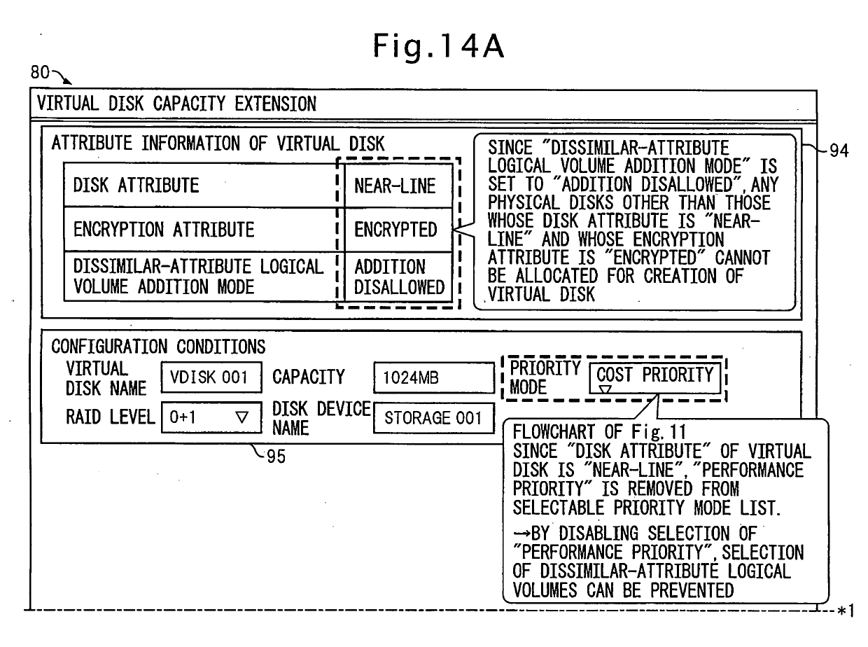

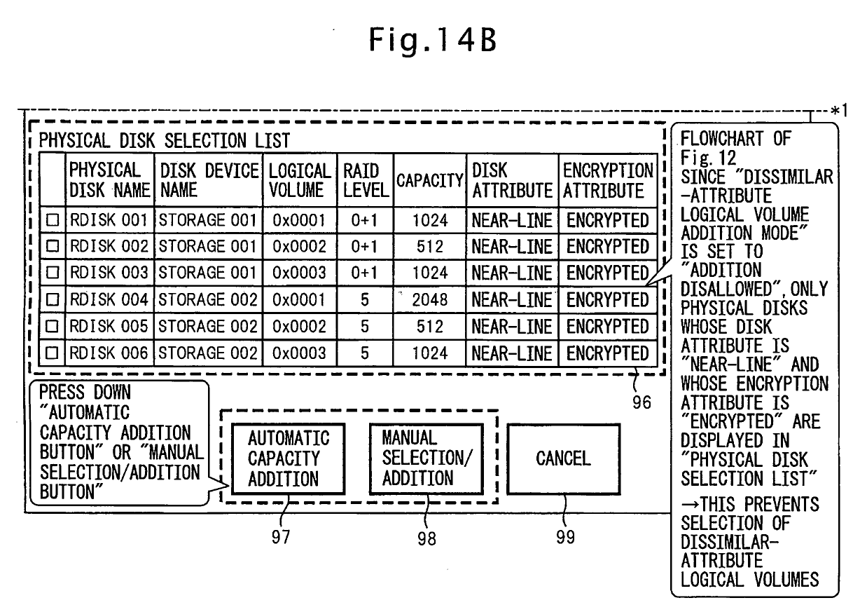

FIGS. 11 and 12 are part 1 and part 2, respectively, of a flowchart explaining the process for allowing/disallowing the addition of a dissimilar-attribute logical volume when extending the virtual disk capacity according to the present embodiment, FIG. 13 is a diagram showing a display screen for explaining the selection of a dissimilar-attribute logical volume addition mode for extending the virtual disk capacity according to the present embodiment, and FIG. 14 is a diagram showing a display screen for explaining the process for allowing/disallowing the addition of a dissimilar-attribute logical volume when extending the virtual disk capacity according to the present embodiment.

The flow for carrying out the process for allowing/disallowing the addition of a dissimilar-attribute logical volume for the extension of the virtual disk capacity under the control of the CPU of the information processing apparatus according to the present embodiment will be described below with reference to FIGS. 11 and 12. The process carried out here is based on the premise that the virtual disk is created in advance by selecting the “dissimilar-attribute logical volume addition mode” at the time of the virtual disk creation.

First, as shown in step S110 of FIG. 11, the operator operates the virtual disk configuration condition selecting button (i.e., the priority mode selecting button) 89 (see FIG. 13) to have the priority mode displayed for the logical volumes registered in the virtual storage pool for the creation of the virtual disk, and selects the “dissimilar-attribute logical volume addition mode” (i.e., the mode for adding a logical volume whose attribute does not match the priority mode of the logical volumes registered in the virtual storage pool) at the time of the virtual disk creation before proceeding to the process described here. Then, the operator presses down the automatic creation button 91 (see FIG. 13) to initiate the process for creating the virtual disk by selecting the specific logical volumes from the logical volumes registered in the virtual storage pool.

Next, as shown in step S111, it is determined whether or not the dissimilar-attribute logical volume addition mode of the target whose capacity is to be extended is set to “ADDITION DISALLOWED.” If the dissimilar-attribute logical volume addition mode of the target is not set to “ADDITION DISALLOWED” (when it is set to “ADDITION ALLOWED”), then three priority modes, i.e., “PERFORMANCE PRIORITY MODE,” “COST PRIORITY MODE,” and “SECURITY PRIORITY MODE,” are set as shown in step S112 as selectable priority modes for the logical volumes used for the creation of the target virtual disk. In this case, the addition of a logical volume whose attribute does not match the priority mode of the logical volumes registered in the virtual storage pool is allowed.

On the other hand, if the dissimilar-attribute logical volume addition mode of the target whose capacity is to be extended is set to “ADDITION DISALLOWED,” then it is detected as shown in step S113 whether or not the disk attribute of the target dissimilar-attribute virtual disk is an on-line disk. If the disk attribute of the target virtual disk is an on-line disk, this means that selecting the performance priority mode is prohibited when extending the virtual disk capacity. Accordingly, as shown in step S114, the performance priority mode is removed from the list of the priority modes selectable for the logical volumes used for the creation of the target virtual disk.

Further, when the dissimilar-attribute logical volume addition mode of the target whose capacity is to be extended is set to “ADDITION DISALLOWED,” then it is detected as shown in step S115 whether or not the disk attribute of the target dissimilar-attribute virtual disk is a near-line disk. If the disk attribute of the target virtual disk is a near-line disk, this means that selecting the cost priority mode is prohibited when extending the virtual disk capacity. Accordingly, as shown in step S116, the cost priority mode is removed from the list of the priority modes selectable for the logical volumes used for the creation of the target virtual disk.

Furthermore, when the dissimilar-attribute logical volume addition mode of the target whose capacity is to be extended is set to “ADDITION DISALLOWED,” then it is detected as shown in step S117 whether or not the encryption attribute of the target dissimilar-attribute virtual disk is en encrypted disk. If the encryption attribute of the target virtual disk is an encrypted disk, this means that selecting the security priority mode is prohibited when extending the virtual disk capacity. Accordingly, as shown in step S118, the security priority mode is removed from the list of the priority modes selectable for the logical volumes used for the creation of the target virtual disk.

When the processing from steps S111 to S118 is completed, the operator operates the priority mode selection button, as shown in step S119, to terminate the process for displaying the priority mode for selecting the logical volumes to create the target virtual disk.

According to the flowchart of FIG. 11, when the dissimilar-attribute logical volume addition mode is set to “ADDITION DISALLOWED,” since the “priority mode” that allows the selection of a dissimilar-attribute logical volume is disabled, the addition of any dissimilar-attribute logical volume can be prevented.

Further, as shown in step S120 of FIG. 12, the physical disk selection list 96 (see FIG. 14) is displayed, and the “dissimilar-attribute logical volume addition mode” is selected. Then, the automatic capacity addition button 97 (see FIG. 14) is pressed down to initiate the process for extending the virtual disk capacity by adding a selected logical volume to the logical volumes registered in the virtual storage pool.

Next, as shown in step S121, it is determined whether or not the dissimilar-attribute logical volume addition mode of the target whose capacity is to be extended is set to “ADDITION DISALLOWED.” If the dissimilar-attribute logical volume addition mode of the target is not set to “ADDITION DISALLOWED,” then as shown in step S122 all physical disks are stored in the storage unit as candidates to be added to extend the virtual disk capacity. In this case, the addition of a dissimilar-attribute logical volume is allowed when creating the virtual disk.

On the other hand, if the dissimilar-attribute logical volume addition mode of the target whose capacity is to be extended is set to “ADDITION DISALLOWED,” then as shown in step S123 the disk attribute (for example, on-line disk or near-line disk) of the target virtual disk is checked whether or not it coincides with the disk attribute of the physical disk to be selected. Further, as shown in step S124, the encryption attribute of the target virtual disk is checked whether or not it coincides with the encryption attribute of the physical disk to be selected.

When it is determined that the disk attribute of the thus checked virtual disk coincides with the disk attribute of the physical disk to be selected, and that the encryption attribute of the thus checked virtual disk coincides with the encryption attribute of the physical disk to be selected, then as shown in step S125 the virtual disk thus checked is stored in the storage unit as a physical disk candidate to be added to extend the virtual disk capacity.

The processing in the above steps S123 to S125 is repeated until all the physical disks to be added to extend the virtual disk capacity are checked (step S126).

When all the physical disks to be added to extend the virtual disk capacity have been checked, the physical disks stored as the physical disk candidates to be added to extend the virtual disk capacity are displayed in the physical disk selection list, as shown in step S127. Finally, when the process for extending the virtual disk capacity is completed, the display of the physical disk selection list is terminated as shown in step S128.

According to the flowchart of FIG. 12, when the dissimilar-attribute logical volume addition mode is set to “ADDITION DISALLOWED,” since the selection of a dissimilar-attribute logical volume is disabled, the addition of any dissimilar-attribute logical volume can be prevented when extending the virtual disk capacity.

Next, one example of the display screen showing the selection of the dissimilar-attribute logical volume addition mode for extending the virtual disk capacity will be described with reference to FIG. 13.

In FIG. 13, the disk device names of two disk devices (STORAGE 001 and STORAGE 002), the physical disk names of six physical disks (RDISK 001 to RDISK 006), and three logical volumes (0x001 to 0x003) in each disk device are shown (in the physical disk selection list) on the display screen 80 of the display unit 8 (see FIG. 5) for the virtual disk creation. The RAID levels of the six physical disks and their capacities are also shown. Here, the RAID level of each of the physical disks 001 to 003 is a combination of RAID 0 and RAID 1, while the RAID level of each of the physical disks 004 to 006 is RAID 5. On the other hand, the capacity of each of the physical disks 001, 003, and 006 is 1024 MB, and the capacity of each of the physical disks 002 and 005 is 512 MB, while the capacity of the physical disk 004 is 2048 MB.

The display screen 80 of FIG. 13 also shows the virtual disk configuration condition selecting button 89 for selecting the priority mode for the virtual disk creation. Here, the priority mode is selectable from among the performance priority, cost priority, and security priority modes. The virtual disk name (VDISK 001) of the virtual disk to be created, the capacity (1024 MB) and RAID level (combination of RAID 0 and RAID 1) of the virtual disk, and the disk device name (STORAGE 001) of the disk device are also shown on the virtual disk configuration condition selecting button 89.

The illustrated example shows the display screen 80 when the operator has selected the performance priority mode by operating the virtual disk configuration condition selecting button 89. Further, for the selection of the dissimilar-attribute logical volume addition mode, either “ADDITION ALLOWED” or “ADDITION DISALLOWED” is selected as the “DISSIMILAR-ATTRIBUTE LOGICAL VOLUME ADDITION MODE” by using the virtual disk configuration condition selecting button 89 at the time of the virtual disk creation. It is also possible to select the manual selection mode by the virtual disk configuration condition selecting button 89; that is, when the manual selection mode is selected, the operator can manually specify each individual logical volume to be used for the creation of the virtual disk.

The display screen 80 of FIG. 13 further shows the automatic creation button 91 and manual selection/creation button 92. When the operator presses down the automatic creation button 91, the virtual disk is created by automatically selecting the logical volumes in accordance with the selected priority mode. On the other hand, when the operator depresses the manual selection/creation button 92, the virtual disk is created by selecting the logical volumes individually specified by the operator through manual operations from the virtual storage pool. A cancel switch 93 is also provided which is used to erase data entered by an erroneous operation of the virtual disk configuration condition selecting button 89, the automatic creation button 91, or the manual selection/creation button 92.

Next, one example of the display screen showing the process for allowing/disallowing the addition of a dissimilar-attribute logical volume when extending the virtual disk capacity will be described with reference to FIG. 14A and FIG. 14B.

In FIG. 14A and FIG. 14B, the disk device names of two disk devices (STORAGE 001 and STORAGE 002), the physical disk names of six physical disks (RDISK 001 to RDISK 006), and three logical volumes (0x001 to 0x003) in each disk device are shown in the physical disk selection list 96 on the display screen 80 of the display unit 8 (see FIG. 5) for the virtual disk capacity extension. The RAID levels of the six physical disks and their capacities are also shown. Here, the RAID level of each of the physical disks 001 to 003 is a combination of RAID 0 and RAID 1, while the RAID level of each of the physical disks 004 to 006 is RAID 5. On the other hand, the capacity of each of the physical disks 001, 003, and 006 is 1024 MB, and the capacity of each of the physical disks 002 and 005 is 512 MB, while the capacity of the physical disk 004 is 2048 MB.

The display screen 80 of FIG. 14A and FIG. 14B also shows the attribute information 94 of the virtual disk. Here, as shown in the attribute information 94 of the virtual disk, the dissimilar-attribute logical volume addition mode is set to “ADDITION DISALLOWED,” while the disk attribute of the disk device is a near-line disk, and the encryption attribute of the disk device is an encrypted disk. Accordingly, physical disks other than those whose disk device disk attribute is a near-line disk and whose disk device encryption attribute is an encrypted disk cannot be allocated for the creation of the virtual disk when extending the virtual disk capacity. Therefore, only the physical disks whose disk device disk attribute is a near-line disk and whose disk device encryption attribute is an encrypted disk are shown in the physical disk selection list 96 as the physical disks that can be added. This prevents the selection of dissimilar-attribute logical volumes, as previously explained with reference to the flowchart of FIG. 12.

The display screen 80 of FIG. 14A further shows the virtual disk configuration condition selecting button 95 for selecting the priority mode for the virtual disk creation when extending the virtual disk capacity. Here, the priority mode is selectable from among the performance priority, cost priority, and security priority modes. The virtual disk name (VDISK 001) of the virtual disk to be created, the capacity (1024 MB) and RAID level (combination of RAID 0 and RAID 1) of the virtual disk, and the disk device name (STORAGE 001) of the disk device are also shown on the virtual disk configuration condition selecting button 95.

The illustrated example shows the display screen 80 when the operator has selected the cost priority mode by operating the virtual disk configuration condition selecting button 95. Further, “ADDITION DISALLOWED” is selected as the “DISSIMILAR-ATTRIBUTE LOGICAL VOLUME ADDITION MODE” by using the virtual disk configuration condition selecting button 95. In this case, since the disk attribute of the target virtual disk is a near-line disk, the performance priority mode is removed from the list of the priority modes selectable when extending the virtual disk capacity. In this way, as previously explained with reference to the flowchart of FIG. 11, since the selection of the performance priority mode is disabled, the addition of any dissimilar-attribute logical volume can be prevented when extending the virtual disk capacity.

The display screen 80 of FIG. 14B further shows the automatic capacity addition button 97 and manual selection/addition button 98. When the operator presses down the automatic capacity addition button 97, the logical volumes to be added are automatically selected and added to the virtual disk. On the other hand, when the operator presses down the manual selection/addition button 98, the logical volumes individually specified by the operator through manual operations are selected and added to the virtual disk. A cancel switch 99 is also provided which is used to erase data entered by an erroneous operation of the virtual disk configuration condition selecting button 95, the automatic capacity addition button 97, or the manual selection/addition button 98.

The following notes are added in relation to the embodiment so far described.

The information processing apparatus according to the above-described embodiment can be applied to any conventional information processing apparatus having a virtualization function for implementing virtual storage by creating a virtual disk in accordance with the attributes of the logical volumes that the operator desires to configure as virtual storage when migrating from the real environment operated by the operator to a virtual environment in a network environment such as SAN that uses a large-capacity storage device such as a disk array device.

1. An information processing apparatus comprising a storage device having a plurality of storage areas, a host device for performing various kinds of information processing on said storage device, and a virtualization switch for connecting said host device to said storage device via at least one path to perform processing for virtualization of said storage device, said apparatus having a virtualization function for implementing virtual storage by creating a virtual disk based on information on a specific logical volume selected from said plurality of storage areas, wherein
said virtualization switch includes an information storing unit in which information concerning the physical configuration of said storage device and information concerning said path are pre-stored, and
said host device includes:
a logical volume selection criterion selecting unit for specifying a selection criterion for selecting a plurality of logical volumes; and
a controller which computes information necessary for the virtualization of said storage device by acquiring the information concerning the physical configuration of said storage device and the information concerning said path from said information storing unit, selects specific logical volumes that match said logical volume selection criterion specified by said logical volume selection criterion selecting unit, and registers said selected logical volumes into a virtual storage pool so that said virtual disk can be created by selecting an optimum logical volume from said virtual storage pool.

2. An information processing apparatus as claimed in claim 1, wherein said logical volume selection criterion includes at least a performance priority mode that gives priority to the performance of said storage device, a cost priority mode that gives priority to the cost of said storage device, and a security priority mode that gives priority to the security of said storage device.

3. An information processing apparatus as claimed in claim 1, wherein when selecting said optimum logical volume from said virtual storage pool, said controller allows said selection to be made from a plurality of zones in the same storage device or from a plurality of storage devices of the same RAID level.

4. An information processing apparatus as claimed in claim 1, wherein said information processing apparatus is provided with a function for judging whether or not a dissimilar-attribute logical volume whose attribute does not match said specified logical volume selection criterion is allowed to be added to said virtual disk constructed from the logical volumes that match said specified logical volume selection criterion, thereby preventing said dissimilar-attribute logical volume from being added to said virtual disk.

5. An information processing apparatus as claimed in claim 2, wherein when selecting said optimum logical volume from said virtual storage pool, said controller allows said selection to be made from a plurality of zones in the same storage device or from a plurality of storage devices of the same RAID level.

6. An information processing apparatus as claimed in claim 2, wherein said information processing apparatus is provided with a function for judging whether or not a dissimilar-attribute logical volume whose attribute does not match said specified logical volume selection criterion is allowed to be added to said virtual disk constructed from the logical volumes that match said specified logical volume selection criterion, thereby preventing said dissimilar-attribute logical volume from being added to said virtual disk.

7. An information processing apparatus comprising a host device for performing various kinds of information processing on a storage device having a plurality of storage areas, said apparatus having a virtualization function for implementing virtual storage by using at least one path for connecting said host device to said storage device and by creating a virtual disk based on information on a specific logical volume selected from said plurality of storage areas, wherein
said host device includes a controller which computes information necessary for the virtualization of said storage device by acquiring pre-stored information concerning the physical configuration of said storage device and pre-stored information concerning said path, selects specific logical volumes that match a logical volume selection criterion pre-specified to select a plurality of logical volumes, and registers said selected logical volumes into a virtual storage pool so that said virtual disk can be created by selecting an optimum logical volume from said virtual storage pool.

8. An information processing apparatus as claimed in claim 7, wherein said logical volume selection criterion includes at least a performance priority mode that gives priority to the performance of said storage device, a cost priority mode that gives priority to the cost of said storage device, and a security priority mode that gives priority to the security of said storage device.

9. An information processing apparatus as claimed in claim 7, wherein when selecting said optimum logical volume from said virtual storage pool, said controller allows said selection to be made from a plurality of zones in the same storage device or from a plurality of storage devices of the same RAID level.

10. An information processing apparatus as claimed in claim 7, wherein said information processing apparatus is provided with a function for judging whether or not a dissimilar-attribute logical volume whose attribute does not match said pre-specified logical volume selection criterion is allowed to be added to said virtual disk constructed from the logical volumes that match said pre-specified logical volume selection criterion, thereby preventing said dissimilar-attribute logical volume from being added to said virtual disk.

11. An information processing apparatus as claimed in claim 8, wherein when selecting said optimum logical volume from said virtual storage pool, said controller allows said selection to be made from a plurality of zones in the same storage device or from a plurality of storage devices of the same RAID level.

12. An information processing apparatus as claimed in claim 8, wherein said information processing apparatus is provided with a function for judging whether or not a dissimilar-attribute logical volume whose attribute does not match said pre-specified logical volume selection criterion is allowed to be added to said virtual disk constructed from the logical volumes that match said pre-specified logical volume selection criterion, thereby preventing said dissimilar-attribute logical volume from being added to said virtual disk.

13. A method of virtualization for implementing virtual storage by using at least one path that connects a storage device having a plurality of storage areas to a host device for performing various kinds of information processing on said storage device and by creating a virtual disk based on information on a specific logical volume selected from said plurality of storage areas, said method comprising:
computing information necessary for the virtualization of said storage device by acquiring pre-stored information concerning the physical configuration of said storage device and pre-stored information concerning said path;
selecting specific logical volumes that match a logical volume selection criterion pre-specified to select a plurality of logical volumes, and registering said selected logical volumes into a virtual storage pool; and
creating said virtual disk by selecting an optimum logical volume from said virtual storage pool.

14. A method of virtualization as claimed in claim 13, wherein said logical volume selection criterion includes at least a performance priority mode that gives priority to the performance of said storage device, a cost priority mode that gives priority to the cost of said storage device, and a security priority mode that gives priority to the security of said storage device.

15. A method of virtualization as claimed in claim 13, further comprising judging whether or not a dissimilar-attribute logical volume whose attribute does not match said pre-specified logical volume selection criterion is allowed to be added to said virtual disk constructed from the logical volumes that match said pre-specified logical volume selection criterion.

16. A method of virtualization as claimed in claim 14, further comprising judging whether or not a dissimilar-attribute logical volume whose attribute does not match said pre-specified logical volume selection criterion is allowed to be added to said virtual disk constructed from the logical volumes that match said pre-specified logical volume selection criterion.

17. A computer-readable recording medium having stored thereon a program for carrying out a method for implementing virtual storage by using at least one path that connects a storage device having a plurality of storage areas to a host device for performing various kinds of information processing on said storage device and by creating a virtual disk based on information on a specific logical volume selected from said plurality of storage areas, wherein the program is used for causing a computer to carry out the steps of:
computing information necessary for the virtualization of said storage device by acquiring pre-stored information concerning the physical configuration of said storage device and pre-stored information concerning said path;
selecting specific logical volumes that match a logical volume selection criterion pre-specified to select a plurality of logical volumes, and registering said selected logical volumes into a virtual storage pool; and
creating said virtual disk by selecting an optimum logical volume from said virtual storage pool.
